(19) United States
(12) Patent Application Publication
(10) Pub. No.: US 2023/0332918 A1
(43) Pub. Date: Oct. 19, 2023

(54) DATA GENERATION APPARATUS, DATA GENERATION METHOD, AND COMPUTER PROGRAM

(71) Applicant: SUMITOMO ELECTRIC INDUSTRIES, LTD., Osaka-shi, Osaka (JP)

(72) Inventors: Tsuyoshi HAGA, Osaka-shi (JP); Tomoya MAEKAWA, Osaka-shi (JP); Tomoyuki KITADA, Osaka-shi (JP)

(73) Assignee: SUMITOMO ELECTRIC INDUSTRIES, LTD., Osaka-shi, Osaka (JP)

(21) Appl. No.: 18/032,877

(22) PCT Filed: Aug. 5, 2021
(86) PCT No.: PCT/JP2021/029144

§ 371 Date: Apr. 20, 2023

(30) Foreign Application Priority Data
Nov. 17, 2020 (JP) 2020-191101

(51) Int. Cl. G01C 21/00

(52) U.S. Cl. CPC G01C 21/3815; G01C 21/3837

(57) ABSTRACT

A data generation apparatus includes a first generation unit configured to, based on altitude data including altitude values of a plurality of points and road map data indicating roads with a plurality of nodes and a plurality of links, generate road altitude data in which each of the plurality of nodes is given an altitude value of a corresponding one of the plurality of points, and a second generation unit configured to, based on the road altitude data, calculate gradient information indicating a gradient between any two nodes among the plurality of nodes and generate road gradient data in which the plurality of nodes or the plurality of links are given the gradient information.

### TECHNICAL FIELD

The present disclosure relates to a data generation apparatus, a data generation method and a computer program.

This application claims priority based on Japanese Patent Application No. 2020-191101 filed on Nov. 17, 2020, and the entire contents of the Japanese patent application are incorporated herein by reference.

### BACKGROUND ART

A route search apparatus (for example, an in-vehicle navigation apparatus) is known for appropriately guiding a vehicle from a departure point to a destination point. In the route search apparatus, based on predetermined road map data, an optimum route in the case of passing from a departure point to a destination point is calculated by using a predetermined route search logic, and the route which is the calculation result is guided to a passenger by an image or voice from, for example, a display or a speaker. The road map data includes, for example, nodes and links assigned corresponding to roads throughout the country.

PTL 1 discloses a technique of creating stereoscopic image data viewed from a traveling vehicle on the basis of road map data and altitude map data in order to display roads, buildings, and the like included in a road map in an in-vehicle navigation apparatus without impairing images thereof.

### PRIOR ART

### Patent Literature

PTL 1: Japanese Unexamined Patent Application Publication No. H10-187029

### SUMMARY OF THE INVENTION

A data generation apparatus of the present disclosure includes a first generation unit configured to, based on altitude data including altitude values of a plurality of points and road map data indicating roads with a plurality of nodes and a plurality of links, generate road altitude data in which each of the plurality of nodes is given an altitude value of a corresponding one of the plurality of points, and a second generation unit configured to, based on the road altitude data, calculate gradient information indicating a gradient between any two nodes among the plurality of nodes and generate road gradient data in which the plurality of nodes or the plurality of links are given the gradient information.

A data generation method of the present disclosure includes a first generation step of, based on altitude data including altitude values of a plurality of points and road map data indicating roads with a plurality of nodes and a plurality of links, generating road altitude data in which each of the plurality of nodes is given an altitude value of a corresponding one of the plurality of points, and a second generation step of, based on the road altitude data, calculating gradient information indicating a gradient between any two nodes among the plurality of nodes and generating road gradient data in which the plurality of nodes or the plurality of links are given the gradient information.

A computer program of present disclosure is a computer program for causing a computer to operate as a data generation apparatus. The computer program includes a first generation step of, based on altitude data including altitude values of a plurality of points and road map data indicating roads with a plurality of nodes and a plurality of links, generating road altitude data in which each of the plurality of nodes is given an altitude value of a corresponding one of the plurality of points, and a second generation step of, based on the road altitude data, calculating gradient information indicating a gradient between any two nodes among the plurality of nodes and generating road gradient data in which the plurality of nodes or the plurality of links are given the gradient information.

### BRIEF DESCRIPTION OF DRAWINGS

FIG. 1 is a diagram showing a functional configuration of a route search system according to an embodiment.

FIG. 2 is a flowchart showing steps of a data generation processing according to an embodiment.

FIG. 3 is a flowchart showing an altitude data generation step according to an embodiment.

FIG. 4 is a diagram schematically showing each data according to an embodiment.

FIG. 5 is a graph schematically showing road altitude data according to an embodiment.

FIG. 6 is a flowchart showing a correction step according to an embodiment.

FIG. 7 is a flowchart showing an elevated road correction step according to an embodiment.

FIG. 8 is a graph showing how altitude values of nodes are corrected in an altitude correction step according to an embodiment.

FIG. 9A is an illustration of a layover correction step according to an embodiment.

FIG. 9B is an illustration of a layover correction step according to an embodiment.

FIG. 10A is an illustration of a shadowing correction step according to an embodiment.

FIG. 10B is an illustration of a shadowing correction step according to an embodiment.

FIG. 11 is a flowchart showing a tunnel road correction step according to a modification.

FIG. 12 is a graph showing an altitude correction step according to a modification.

### DETAILED DESCRIPTION

### Problems to be Solved by the Invention

With the development of autonomous driving technology and the development of electric vehicle (EV) technology, there is an increasing need for guidance on a more suitable route.

In view of such problems, it is an object of the present disclosure to provide data capable of guiding a more preferable route.

### Effects of the Invention

According to the present disclosure, it is possible to provide data capable of guiding a more preferable route.

### DESCRIPTION OF EMBODIMENTS OF PRESENT DISCLOSURE

Embodiments of the present disclosure include at least the following.

(1) A data generation apparatus according to the present disclosure includes a first generation unit configured to, based on altitude data including altitude values of a plurality of points and road map data indicating roads with a plurality of nodes and a plurality of links, generate road altitude data in which each of the plurality of nodes is given an altitude value of a corresponding one of the plurality of points, and a second generation unit configured to, based on the road altitude data, calculate gradient information indicating a gradient between any two nodes among the plurality of nodes and generate road gradient data in which the plurality of nodes or the plurality of links are given the gradient information.

According to the data generation apparatus of the present disclosure, it is possible to provide data (road gradient data) capable of guiding a more preferable route.

(2) The data generation apparatus may further include a third generation unit configured to generate the altitude data, based on synthetic aperture radar (SAR) data obtained by a synthetic aperture radar. With this configuration, altitude data of a wider area can be acquired in a shorter cycle. Here, SAR is an acronym for synthetic aperture radar (Synthetic Aperture Radar).

(3) The third generation unit may be configured to generate a plurality of pieces of the altitude data, based on the SAR data observed on different dates and times, and regard a statistical value of the generated plurality of pieces of the altitude data as a true value of the altitude data. With this configuration, the influence of, for example, weather can be leveled, and more accurate altitude data can be acquired.

(4) The data generation apparatus may further include a correction unit configured to correct an altitude value given to a node among the plurality of nodes. The correction unit may be configured to correct an altitude value of an abnormal node, based on an altitude value of a normal node, the abnormal node being a node, among the plurality of nodes, that satisfies a correction condition, the normal node being a node, among the plurality of nodes, that does not satisfy the correction condition and is adjacent to the abnormal node, and the second generation unit may be configured to generate the road gradient data, based on the road altitude data that has been corrected. With this configuration, even when the road altitude data includes an altitude value different from the actual altitude value, a more accurate altitude value can be acquired by correction.

(5) The abnormal node may include a first abnormal node connected to a target link, the target link being a link corresponding to an elevated road and having a gradient exceeding a first predetermined value, the gradient being between a start point and an end point of the link, the normal node may include a first normal node adjacent to the first abnormal node and connected to a non-target link, the non-target link not being the target link, and the correction unit may be configured to correct an altitude value of the first abnormal node, based on an altitude value of the first normal node.

Since the maximum gradient of a road is prescribed by law, the road altitude data of a link whose gradient exceeds the first predetermined value often includes an altitude value different from the actual value. The correction unit extracts a node connected to such a link as a first abnormal node and corrects the altitude value of the node, thereby obtaining a more accurate altitude value.

(6) The correction unit may be configured to determine whether the link corresponds to an elevated road, based on a reflection intensity of at least one of a point corresponding to the link or a point located within a range of a predetermined distance from the point, in a reflection intensity image representing an intensity of a reflected wave returning from a ground surface to a satellite.

By determining whether or not the road corresponding to the link is an elevated road based on the reflection intensity, the first abnormal node can be extracted in a shorter time.

(7) The abnormal node may include a second abnormal node corresponding to a point at which a local incident angle in the SAR data is smaller than a second predetermined value. The normal node may include a second normal node adjacent to the second abnormal node and corresponding to a point at which the local incident angle is greater than the second predetermined value, and the correction unit may be configured to correct an altitude value of the second abnormal node, based on an altitude value of the second normal node.

When the SAR data is used, the layover should be noted. The smaller the local incident angle, the higher the possibility of occurrence of layover. The correction unit can extract a node corresponding to a point whose local incident angle is smaller than the second predetermined value as the second abnormal node, and correct the altitude value of the second abnormal node to obtain a more accurate altitude value.

(8) The abnormal node may include a third abnormal node corresponding to a point at which a local incident angle in the SAR data is greater than a third predetermined value, the normal node may include a third normal node adjacent to the third abnormal node and corresponding to a point at which the local incident angle is smaller than the third predetermined value, and the correction unit may be configured to correct an altitude value of the third abnormal node, based on an altitude value of the third normal node.

When the SAR data is used, the radar shadow should be noted. The larger the local incident angle is, the higher the possibility of occurrence of radar shadow. The correction unit may extract a node corresponding to a point whose local incident angle is greater than the third predetermined value as the third abnormal node, and correct the altitude value of the node to obtain a more accurate altitude value.

(9) The abnormal node may include a second abnormal node corresponding to a point at which a local incident angle in the SAR data is smaller than a second predetermined value, the local incident angle smaller than the second predetermined value causing layover in the SAR data, and a third abnormal node corresponding to a point at which the local incident angle is greater than a third predetermined value, the local incident angle greater than the third predetermined value causing radar shadow in the SAR data, the third predetermined value may be greater than the second predetermined value, the normal node may include a second normal node adjacent to the second abnormal node and corresponding to a point at which the local incident angle is greater than the second predetermined value and smaller than the third predetermined value, and a third normal node adjacent to the third abnormal node and corresponding to a point at which the local incident angle is greater than the second predetermined value and smaller than the third predetermined value, and the correction unit may be configured to correct an altitude value of the second abnormal node, based on an altitude value of the second normal node, and correct an altitude value of the third abnormal node, based on an altitude value of the third normal node.

When the SAR data is used, the layover and radar shadow should be noted. The smaller the local incident angle, the higher the possibility of occurrence of layover. The correction unit can extract a node corresponding to a point whose local incident angle is smaller than the second predetermined value as the second abnormal node, and correct an altitude value of the second abnormal node to obtain a more accurate altitude value. In addition, the larger the local incident angle, the higher the possibility of occurrence of radar shadow. The correction unit can extract a node corresponding to a point whose local incident angle is greater than the third predetermined value as the third abnormal node, and correct the altitude value of the third abnormal node to obtain a more accurate altitude value.

(10) The abnormal node may include a fourth abnormal node connected to a tunnel link, the tunnel link being a link corresponding to a tunnel road, the normal node may include a fourth normal node connected to a non-tunnel link, the non-tunnel link being a link adjacent to the fourth abnormal node and corresponding to a road other than the tunnel road, and the correction unit may be configured to correct an altitude value of the fourth abnormal node, based on an altitude value of the fourth normal node.

Since the SAR data is acquired based on the wave reflected from the ground surface, when the road corresponding to the link is a tunnel road, the road altitude data often includes an altitude value different from the actual altitude value. The correction unit extracts a node connected to such a link as the fourth abnormal node and corrects the altitude value of the fourth abnormal node, thereby obtaining a more accurate altitude value.

(11) A data generation method of the present disclosure includes a first generation step of, based on altitude data including altitude values of a plurality of points and road map data indicating roads with a plurality of nodes and a plurality of links, generating road altitude data in which each of the plurality of nodes is given an altitude value of a corresponding one of the plurality of points, and a second generation step of, based on the road altitude data, calculating gradient information indicating a gradient between any two nodes among the plurality of nodes and generating road gradient data in which the plurality of nodes or the plurality of links are given the gradient information.

According to the data generation method of the present disclosure, it is possible to provide data (road gradient data) capable of guiding a more preferable route.

(12) A computer program of present disclosure is a computer program for causing a computer to operate as a data generation apparatus. The computer program includes a first generation step of, based on altitude data including altitude values of a plurality of points and road map data indicating roads with a plurality of nodes and a plurality of links, generating road altitude data in which each of the plurality of nodes is given an altitude value of a corresponding one of the plurality of points, and a second generation step of, based on the road altitude data, calculating gradient information indicating a gradient between any two nodes among the plurality of nodes and generating road gradient data in which the plurality of nodes or the plurality of links are given the gradient information.

According to the computer program of the present disclosure, it is possible to provide data (road gradient data) capable of guiding a more preferable route.

### DETAILS OF EMBODIMENTS OF PRESENT DISCLOSURE

The details of embodiments of the present disclosure will now be described with reference to the drawings.

In recent years, with the development of electric vehicle (EV) technology, a route guidance service for EVs is required. For example, an attempt has been made to alleviate a passenger's anxiety that the remaining battery level of an EV will run out on the way to a destination point by not only guiding a route from a departure point to the destination point, but also presenting an optimal timing for charging the EV to the passenger in consideration of various conditions such as road congestion, inclination, and weather.

In particular, in the case of an EV, unlike a gasoline vehicle, a decrease in the battery remaining amount is large when traveling uphill, whereas the battery remaining amount can be increased by charging when traveling downhill in some cases. For this reason, in order to predict the battery remaining amount of the EV from the traveling route of the EV, information on the inclination (gradient information) of the road is important. The gradient information includes, for example, a gradient of a road.

In order to calculate a gradient of a road, altitude data including an altitude value of each point is required. The altitude data can be acquired from road maps published by, for example, the Geographical Survey Institute, the National Aeronautics and Space Administration (NASA), or road maps sold by general companies. However, since there is a region where a road map including altitude data does not exist, or since the actual height of a road and the altitude value of the road map do not coincide with each other in some cases, it is not possible to calculate suitable gradient information using the altitude data which can be acquired conventionally.

For example, in a mountainous region, when an elevated road extends over a valley portion, the actual height of the road may not match the altitude value of the altitude data. This is because the altitude value of the altitude data indicates not the altitude of the surface of the elevated road but the altitude of the ground surface (i.e., the altitude of the valley bottom). Also, when a tunnel road is provided so as to pass through a mountain in a mountainous region, the altitude value of the altitude data indicates not the altitude of the surface of the tunnel road but the altitude of the ground surface (i.e., the altitude of the surface of the mountain), so that the actual height of the road may not match the altitude value of the altitude data.

Further, when the update cycle of the altitude data is long (for example, in the case of update every one year to ten years), it is not possible to acquire an actual altitude value for a place where the height of the road has changed due to, for example, cutting of a mountain and banking after the update of the altitude value.

Therefore, a route search system 100 of the present disclosure generates altitude data based on data obtained by a synthetic aperture radar (SAR) (hereinafter referred to as “SAR data”) that is obtainable for an area wider than a road map including an altitude value and updated at a cycle shorter than that of the road map including the altitude value, and generates gradient data including a gradient information based on the altitude data and the road map data.

The SAR data is data obtained by emitting a radio wave (for example, a microwave) from a satellite toward a ground surface and receiving the radio wave reflected on the ground surface by a sensor of the satellite. The SAR date are disclosed in various regions and countries by, for example, Japan Aerospace Exploration Agency (JAXA), European Space Agency (ESA), Canadian Space Agency (CSA). The update cycle of the SAR data is shorter than that of a road map published by, for example, the Geographical Survey Institute, and is, for example, one week to several months.

### <<Overall Configuration of Route Search System>>

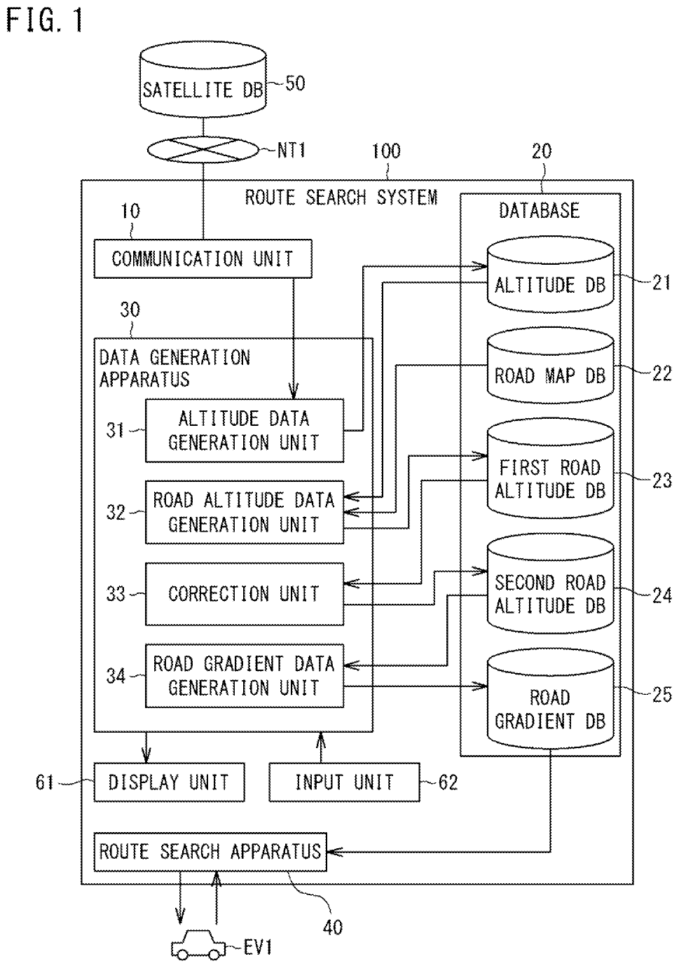

FIG. 1 is a diagram showing a functional configuration of route search system 100 according to an embodiment. Route search system 100 includes, as a functional configuration, a communication unit 10, a database 20, a data generation apparatus 30, a route search apparatus 40, a display unit 61, and an input unit 62. Route search system 100 includes, as a hardware configuration, a calculation unit (for example, a CPU or a GPU), a main storage unit (for example, a RAM), a storage (for example, an HDD or an SSD), a communication interface functioning as communication unit 10, a display and a speaker functioning as display unit 61, and a keyboard and a mouse functioning as input unit 62. Route search system 100 is, for example, a general-purpose computer or a general-purpose server.

Route search system 100 exhibits a function as data generation apparatus 30 and a function as route search apparatus 40 by the calculation unit executing a predetermined program. Database 20 is stored in the storage of route search system 100. Instead of storing database 20 in route search system 100, database 20 may be stored in an external storage on the cloud (a storage outside route search system 100), and route search system 100 may be configured to access the external storage.

Communication unit 10 acquires SAR data from a satellite database 50 via a communication network NT1 (for example, the Internet). Satellite database 50 is, for example, a database of an organization that discloses SAR data. The SAR data acquired by communication unit 10 is input to data generation apparatus 30. Although FIG. 1 shows an example in which the SAR data acquired from satellite database 50 is directly input to data generation apparatus 30, the acquired SAR data may be temporarily stored in database 20 and data generation apparatus 30 may be configured to read the SAR data from database 20.

Database 20 includes an altitude database 21 including an altitude data D1, a road map database 22 including a road map data D2, a first road altitude database 23 including a road altitude data D3, a second road altitude database 24 including a corrected data D4, and a road gradient database 25 including a road gradient data D5.

Data generation apparatus 30 includes an altitude data generation unit 31 (“third generation unit” in the present disclosure), a road altitude data generation unit 32 (“first generation unit” in the present disclosure), a correction unit 33, and a road gradient data generation unit 34 (“second generation unit” in the present disclosure). Each of these units 31 to 34 is a functional unit that is realized by the calculation unit executing a predetermined program. Data generation apparatus 30 uses the SAR data and road map data D2 as original data to generate road gradient data D5 by a data generation method described later.

Based on the search request received from an electric vehicle EV1 and road gradient data D5, route search apparatus 40 predicts the remaining battery level at each point in the route along which electric vehicle EV1 travels.

### <<Data Generation Processing>>

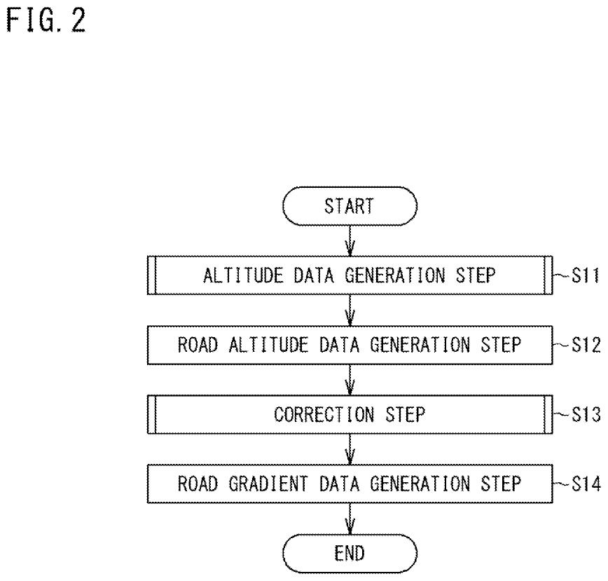

FIG. 2 is a flowchart showing the steps of a data generation processing performed by data generation apparatus 30. Hereinafter, each step of the data generation processing will be described with reference to FIG. 1 as appropriate.

When the data generation processing is started in data generation apparatus 30, an altitude data generation step S11 is first executed. In altitude data generation step S11, altitude data generation unit 31 generates altitude data D1 including altitude information of each point based on the SAR data.

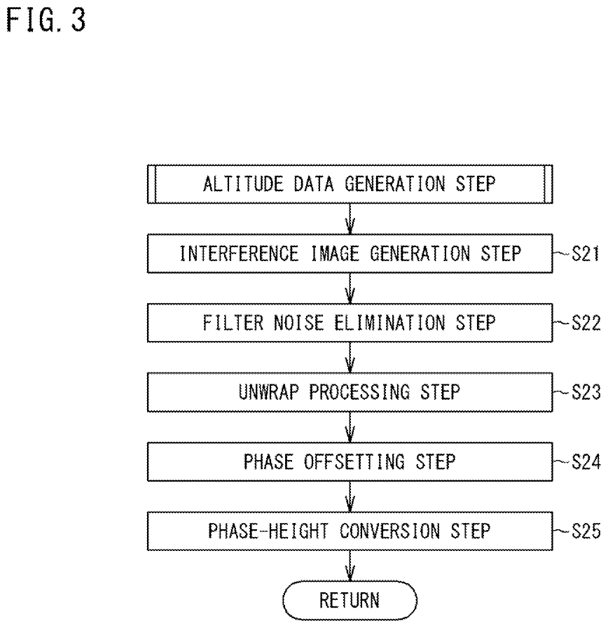

FIG. 3 is a flowchart showing an example of a subroutine of altitude data generation step S11. When altitude data D1 is generated from the SAR data, various known methods may be applied in addition to the method described below. In altitude data generation step S11, first, an interference image (interferogram) is generated based on two pieces of SAR data acquired by performing observation twice on the same point on the ground surface (an interference image generation step S21). In the interference image, the phase information is folded in a range from 0 degrees to 360 degrees. Next, a noise portion such as a phase singular point is removed by filter processing (a filter noise elimination step S22). For example, the noise portion is replaced by the arithmetic mean of its surrounding values. Thereafter, the folded phase information of the interference image is unwrapped to the absolute value of the phase (the value of the actual distance) (an unwrap processing step S23).

The absolute value of the phase is offset by various conditions (a phase offsetting step S24). Finally, the absolute value of the phase after the offset is converted into the altitude value (z) of the ground surface using Digital Elevation Model (DEM) data (DEM data) (a phase-height conversion step S25). Thus, altitude data D1 including the altitude value (z) of each point (x, y) of the ground surface as the coordinate information (x, y, z) is generated. Altitude data D1 generated by altitude data generation unit 31 is stored in altitude database 21. Thus, altitude data generation step S11 is completed.

Altitude data generation unit 31 acquires new SAR data every predetermined cycle (for example, every several weeks) and generates altitude data D1. That is, altitude data generation step S11 is executed at any time. As a result, altitude data D1 of altitude database 21 is updated every predetermined cycle.

Reference is made to FIGS. 1 and 2. Next, road altitude data generation unit 32 generates road altitude data D3 based on altitude data D1 and road map data D2 (a road altitude data generation step S12, “first generation step” in present disclosure).

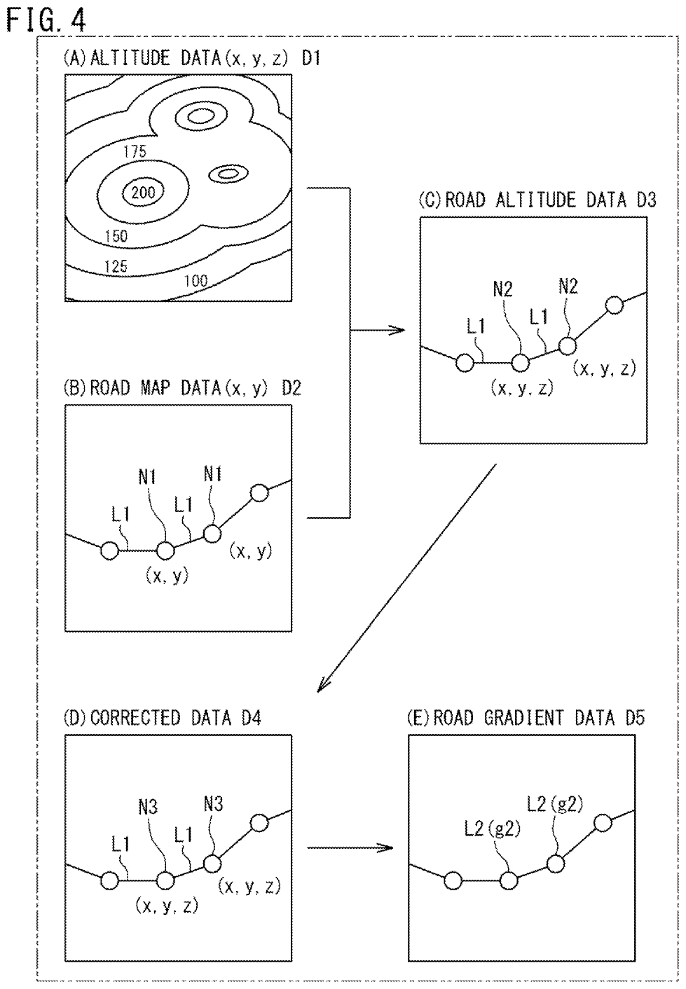

FIG. 4 is a diagram schematically showing data D1 to D5.

Part (A) of FIG. 4 shows altitude data D1. For convenience, in part (A) of FIG. 4, points having the same altitude value (z) are connected by a line and shown as a contour image. Part (B) of FIG. 4 shows road map data D2. Part (C) of FIG. 4 shows road altitude data D3. Part (D) of FIG. 4 shows corrected data D4. Part (E) of FIG. 4 shows road gradient data D5.

Road map data D2 is the data related to a road configuration and includes a directed graph having a plurality of nodes N1 and a plurality of links L1. Road map data D2 is transmitted as needed from, for example, a data center (not shown) to route search system 100, and road map database 22 is updated as needed.

The plurality of nodes N1 are respectively set at intersections of roads, for example. The plurality of nodes N1 are set at predetermined intervals (for example, every 10 m) at intermediate points on the road other than the intersections. Each of the plurality of nodes N1 has planar coordinate information (x, y). The coordinate information (x, y) is, for example, the latitude and longitude of the point at which node N1 is provided.

Links L1 are set to connect adjacent nodes N1. Link L1 represents the actual road line shape and driving direction. In order to indicate the traveling direction, link L1 has directivity. In the case of a one way road, only one directional link L1 is set, and in the case of a two way road, a pair of links L1 having different directions are set. Link L1 includes information on a road type and information on a link cost LC. The road type includes, for example, a type of a general road or a toll road, a type of an elevated road, a tunnel road, or an underground passage, a designed speed of a road, and a category of a road defined by law. Link cost LC is a numerical value of a load applied to the vehicle when the vehicle passes through link L1.

In road altitude data generation step S12, first, road altitude data generation unit 32 reads altitude data D1 and road map data D2 from altitude database 21 and road map database 22. Next, based on altitude data D1, the altitude value (z) of the point corresponding to the coordinate information (x, y) of node N1 of road map data D2 is extracted. Then, a node N2 is generated by adding the extracted altitude value (z) to the coordinate information (x, y) of node N1. That is, the newly generated coordinate information (x, y, z) of node N2 includes the altitude value (z). As a result, road altitude data D3 including a plurality of nodes N2 and a plurality of links L1 is generated. Finally, road altitude data generation unit 32 stores road altitude data D3 in first road altitude database 23. Thus, road altitude data generation step S12 is completed.

Road altitude data generation unit 32 acquires new altitude data D1 and road map data D2 every predetermined cycle (for example, every several weeks) to generate road altitude data D3. That is, road altitude data generation step S12 is executed at any time. As a result, road altitude data D3 of first road altitude database 23 is updated every predetermined cycle.

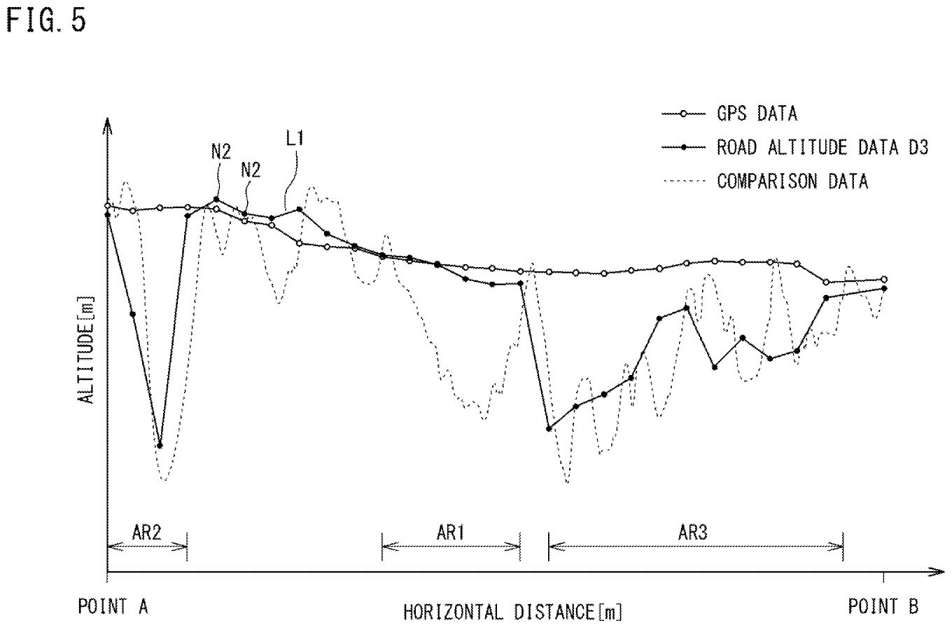

FIG. 5 is a graph schematically showing road altitude data D3. In the graph of FIG. 5, the horizontal axis represents the horizontal distance from a predetermined point A to a point B, and the vertical axis represents the altitude. In the graph of FIG. 5, a black circle indicates node N2 of road altitude data D3, and a line connecting adjacent black circles indicates link L1 of road altitude data D3. FIG. 5 shows, as a comparative example, altitude data (hereinafter referred to as “comparison data”) obtained from the road map of the Geographical Survey Institute of Japan is shown as a dashed line.

In FIG. 5, as a reference example, altitude data acquired by a quasi-zenith satellite system (hereinafter referred to as “GPS data”) when a vehicle loaded with a GPS (Global Positioning System) tracker is actually made to travel from point A to point B is shown as an open circle line. The GPS data is so-called correct data that almost accurately represents the actual height of the road. However, in order to acquire the GPS data, it is necessary for the vehicle to actually travel on the road as described above, and thus it is not realistic to acquire the GPS data for all the roads.

Attention is paid to an area indicated by an arrow AR1 in FIG. 5 (hereinafter referred to as “area AR1”). In area AR1, the altitude value of the comparison data decreases in a valley shape. On the other hand, the altitude value of the GPS data does not have a valley shape, and area AR1 is shown as a relatively flat road. Actually, the road from point A to point B is an expressway opened two years before the acquisition of the GPS data, and area AR1 is a newly opened service area. Since the expressway and the service area are constructed after the latest update time of the comparison data, the valley before the service area is created is indicated as the altitude value in the comparison data.

On the other hand, the altitude value of road altitude data D3 indicates substantially the same value as the altitude value of the GPS data. This is because the update cycle of the SAR data is shorter than the update cycle of the comparison data, the ground surface after the service area is created can be indicated as the altitude value for area AR1. As described above, by generating altitude data D1 using the SAR data having a short update cycle and generating road altitude data D3 based on altitude data D1, it is possible to acquire an altitude value closer to the actual altitude value even when a change in topography occurs.

Next, attention is paid to an area indicated by an arrow AR2 in FIG. 5 (hereinafter referred to as “area AR2”). In area AR2, the altitude value of the comparison data decreases in a valley shape. In contrast, the altitude value of the GPS data is shown as a relatively flat road. Area AR2 is actually an elevated road (e.g., a road bridge) spanning a valley. In the GPS data, a flat altitude value is correctly obtained because the vehicle travels on the elevated road. Since the elevated road is generated after the latest update time of the comparison data, the valley bottom is indicated as the altitude value in the comparison data. When the position indicated by the altitude value of the comparison data is not a road but a ground surface, even if the comparison data is updated after the completion of the elevated road, the altitude value of a road higher than the ground surface, such as the elevated road, is not indicated as the altitude value of the comparison data. In this case, the comparison data of area AR2 remains valley-like even if it is updated after the completion of the elevated road.

The altitude value of road altitude data D3 indicates almost the same value as the altitude value of the comparison data. This is because the width of the elevated road is narrower than, for example, the resolution of the SAR data, and thus the altitude of the valley bottom is acquired as the altitude value in the SAR data.

A portion indicated by an arrow AR3 in FIG. 5 (hereinafter referred to as “area AR3”) is actually an elevated road. In area AR3, similarly to area AR2, the altitude value of the GPS data is correctly shown as a relatively flat road, whereas the altitude values of the comparison data and road altitude data D3 are shown in a valley shape.

As described above, road altitude data D3 may include an altitude value different from the actual altitude value due to, for example, the resolution of the SAR data. Therefore, in order to bring the altitude value of road altitude data D3 closer to the actual altitude value, correction unit 33 performs a correction step S13 (FIG. 2) to be described below. In correction step S13, node N2 including the altitude value different from the actual value is extracted under various correction conditions to be described later. Then, the extracted altitude value of node N2 is corrected based on the altitude value of node N2 which does not satisfy the correction condition (that is, includes an actual altitude value).

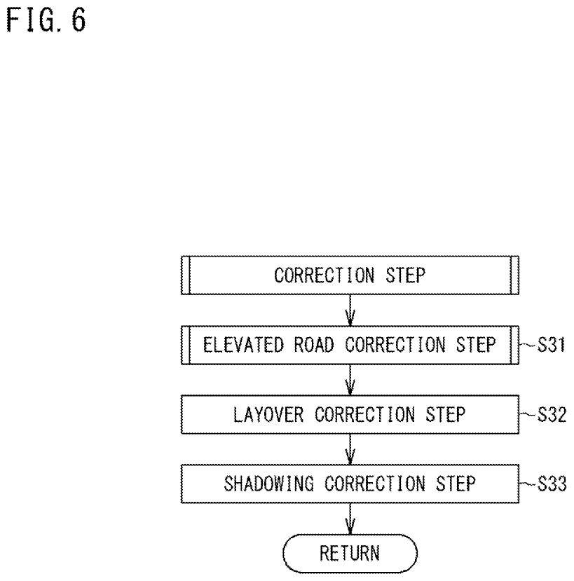

FIG. 6 is a flowchart showing an example of a subroutine of correction step S13. In the embodiment of the present disclosure, correction unit 33 performs an elevated road correction step S31, a layover correction step S32, and a shadowing correction step S33 in this order in correction step S13. However, the order of steps S31 to S33 is not limited thereto, and may be any order. In addition, correction unit 33 may execute only two or one of steps S31 to S33.

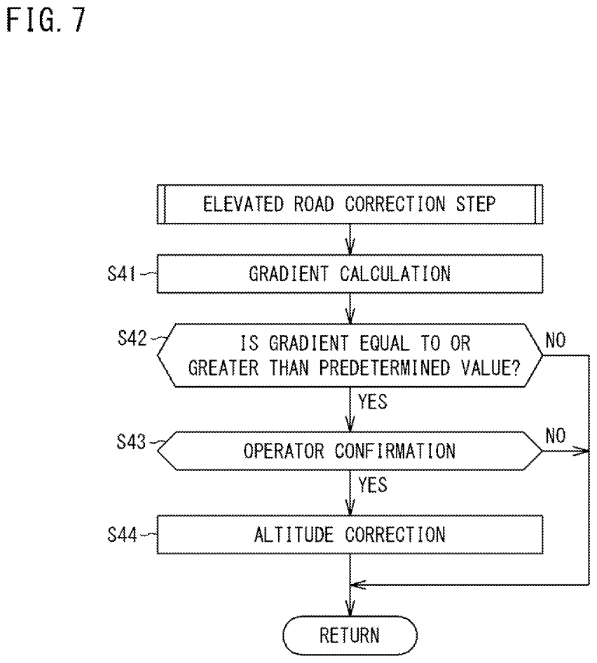

FIG. 7 is a flowchart showing an example of a subroutine of elevated road correction step S31. In elevated road correction step S31, node N2 which is actually an elevated road but is highly likely to acquire the altitude other than the elevated road such as the valley bottom in the SAR data as the altitude value is extracted based on the gradient and the road type of link L1, and the altitude value of node N2 is corrected.

In Japan, the law stipulates the maximum value of the gradient for each type of road. For example, the maximum value of the gradient is stipulated as 6% or less in principle for a Type 3 ordinary road (for example, a general national road) having a design speed of 50 km/h. In addition, the maximum value of the gradient is stipulated as 4% or less in principle for a Type 1 ordinary road (for example, an expressway) having a design speed of 80 km/h. Therefore, for example, when a gradient g1 of link L1 exceeds 4% even though the road type of link L1 is an expressway with a design speed of 80 km/h, there is a high possibility that the SAR data erroneously acquire the altitude of, for example, a valley bottom instead of the road. In elevated road correction step S31, gradient g1 is calculated for each link L1, and when gradient g1 exceeds a predetermined maximum value set for each road type, the altitude value of node N2 is corrected.

First, correction unit 33 reads road altitude data D3 from first road altitude database 23. Next, correction unit 33 calculates gradient g1 between the start point and the end point of link L1 in road altitude data D3 (a gradient calculation step S41).

Gradient g1 is obtained by dividing the vertical distance between two points by the horizontal distance and multiplying the result by 100. The unit of gradient g1 is %. For example, when node N2 located at the start point of link L1 has coordinate information (x1, y1, z1) and node N2 located at the end point of link L1 has coordinate information (x2, y2, z2), gradient g1 of link L1 is expressed by the following Equation (1). Gradient g1 may indicate the inclination of the surface with respect to the horizontal plane by an “angle”. In the embodiment of the present disclosure, gradient g1 is calculated one for each link L1 as described above. That is, if there are 100 links L1, 100 gradients g1 are calculated.

$$\begin{matrix}[ Equation 1 ] & \\ g 1 = \frac{\sqrt{{( Z 2 - Z 1 )}^{2}}}{\sqrt{\{ {( x 2 - x 1 )}^{2} + {( y 2 - y 1 )}^{2} \}}} \times 100 & ( 1 )\end{matrix}$$

Next, correction unit 33 extracts link L1 in which gradient g1 exceeds a first predetermined value (an extraction step S42). If gradient g1 of link L1 exceeds the first predetermined value, the process proceeds to an operator confirmation step S43 (YES route of S42 in FIG. 7). If gradient g1 of link L1 is equal to or less than the first predetermined value (NO route of S42 in FIG. 7), elevated road correction step S31 is completed.

Here, the first predetermined value is the maximum gradient allowed as the road gradient, and is set for each road type of link L1. The relationship between the road type and the first predetermined value is stored in a storage area of database 20 or data generation apparatus 30 as data in a table format, for example. For example, when the road type is a general national road with a design speed of 50 km/h, the first predetermined value is 6%. When the road type is an expressway with a design speed of 80 km/h, the first predetermined value is 4%.

Next, correction unit 33 displays the satellite photograph of the point including link L1 in which gradient g1 exceeds the first predetermined value on display unit 61, and receives an input from the operator to input unit 62 (operator confirmation step S43). When the operator visually observes the satellite photograph and confirms that the elevation correction is necessary for the points including link L1 (for example, that there is an elevated road at the points including link L1), the operator inputs the fact with input unit 62. For example, the operator clicks the “elevated present” button displayed on display unit 61 with the mouse. In this case, the process proceeds to an altitude correction step S44 (YES route of S43 in FIG. 7).

In addition, when the operator visually observes the satellite photograph and confirms that the correction of the altitude is not necessary for the points including link L1 (for example, there is no elevated road at the points including link L1 and there is a road steeper than a prescribed gradient), the operator inputs the fact with input unit 62. For example, the operator clicks the “elevated absent” button displayed on display unit 61 with the mouse. In this case, elevated road correction step S31 is completed (NO route of S43 in FIG. 7).

When the road type of link L1 includes information indicating whether or not the road is an elevated road, correction unit 33 may perform an elevated presence/absence determination step instead of operator confirmation step S43. In this case, it is possible to omit a step in which the operator visually observes the satellite photograph. That is, when the road type of link L1 whose gradient g1 exceeds the first predetermined value is the elevated road, the process proceeds to altitude correction step S44, and when the road type of link L1 is other than the elevated road, elevated road correction step S31 is completed.

Next, correction unit 33 corrects the altitude value of node N2 (altitude correction step S44).

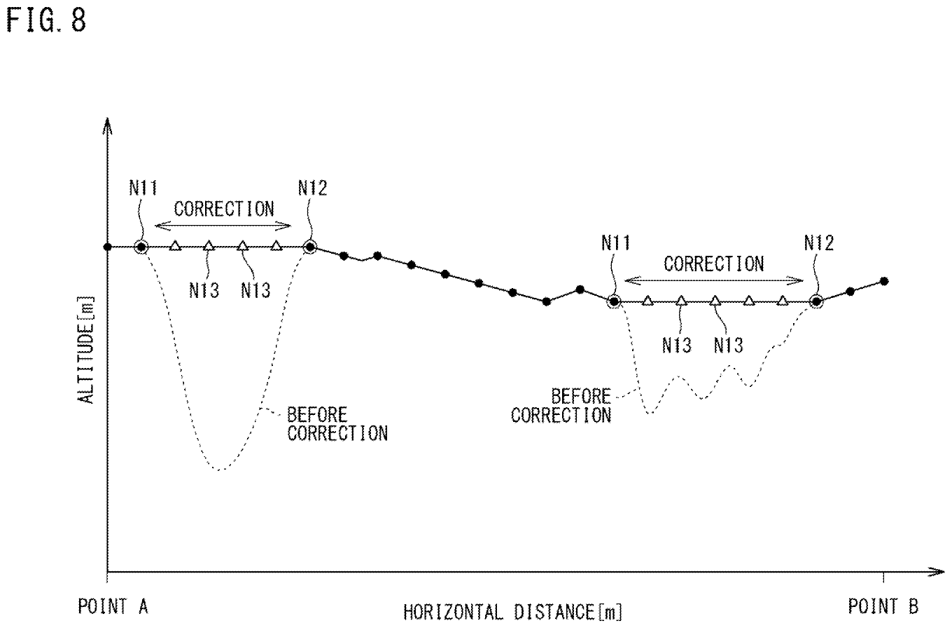

FIG. 8 is a graph showing how the altitude value of node N2 is corrected in altitude correction step S44. In FIG. 8, node N2 connected to link L1 (hereinafter, such link L1 is referred to as “target link”) corresponding to an expressway and having gradient g1 exceeding the first predetermined value is designated as an “abnormal node N13”. Link L1 corresponding to the expressway is link L1 to which the operator inputs that correction is necessary or link L1 whose road type is the elevated road. FIG. 8 includes an area in which four abnormal nodes N13 continuously appear adjacent to the point A and an area in which five abnormal nodes N13 continuously appear adjacent to the point B. These areas correspond to area AR2 and area AR3 in FIG. 5, respectively.

Node N2 that is adjacent to abnormal node N13 via link L1 and is connected to a non-target link that is not the target link among links L1 is referred to as a “normal node”. In FIG. 8, the normal nodes are indicated as normal nodes N11 and N12. Specifically, the non-target link is link L1 that satisfies at least one of the following conditions: link L1 does not correspond to an expressway; and gradient g1 is equal to or less than the first predetermined value. Normal node N11 is a node adjacent to abnormal node N13 at a position closer to the point A than to abnormal node N13 (first position). Normal node N12 is a node adjacent to abnormal node N13 at a position closer to the point B than to abnormal node N13 (second position).

Correction unit 33 corrects the altitude value of abnormal node N13 based on the altitude values of normal nodes N11 and N12. For example, correction unit 33 changes the altitude value of abnormal node N13 to an average value of the altitude value of normal node N11 and the altitude value of normal node N12. For example, when normal node N11 has an altitude value z11 and normal node N12 has an altitude value z12, a corrected altitude value z13 of abnormal node N13 is (z11+z12)/2. Thus, elevated road correction step S31 is completed.

Here, an original altitude value z13 of abnormal node N13 tends to be a value closer to altitude value z11 of normal node N11 when abnormal node N13 is a point closer to normal node N11, and tends to be a value closer to altitude value z12 of normal node N12 when abnormal node N13 is a point closer to normal node N12. Therefore, when the altitude value of abnormal node N13 is corrected, the horizontal distance between normal nodes N11 and N12 and abnormal node N13 may be taken into account. For example, when the horizontal distance between normal node N11 and abnormal node N13 is a and the horizontal distance between normal node N12 and abnormal node N13 is (3, altitude value z13 after correction is z11+((z11−z12)/(α+β))×α.

By correcting the altitude value of node N2 in altitude correction step S44, the altitude values of corrected road altitude data D3 (i.e., corrected data D4) in area AR2 and area AR3 indicate almost the same values as the altitude values of the GPS data. As described above, even when road altitude data D3 includes an area (i.e., abnormal node) having an altitude value different from the actual altitude value due to, for example, the resolution of the SAR data, the area is extracted based on the correction condition such as the gradient of link L1 or the road type, and the altitude value of the area is corrected based on the altitude value of the neighboring node N2 (i.e., normal node) that does not satisfy the correction condition, so that the altitude value can be brought close to the actual altitude value (GPS data). Thus, a more accurate altitude value can be obtained.

Reference is made to FIG. 6. Next, correction unit 33 executes layover correction step S32 and shadowing correction step S33. When the SAR data is used, layover and radar shadow should be noted. The layover is a phenomenon in which a tall building or mountain is determined to be close to the satellite and is thus observed as if the tall building or mountain falls on the satellite side in the SAR data. The radar shadow is a phenomenon in which a radio wave emitted from a satellite is blocked by a tall building or a mountain so that the radio wave does not reach the rear side of the building or the mountain, and information of a portion which is a shadow of, for example, the mountain cannot be obtained. In areas where layover or radar shadow occurs, there is a high possibility that the altitude value of node N2 is inaccurate. Therefore, in the embodiment of the present disclosure, by layout over correction step S32 and shadowing correction step S33, the area in which the layout over or the radar shadow occurs is extracted, and the altitude value of node N2 included in the area is corrected.

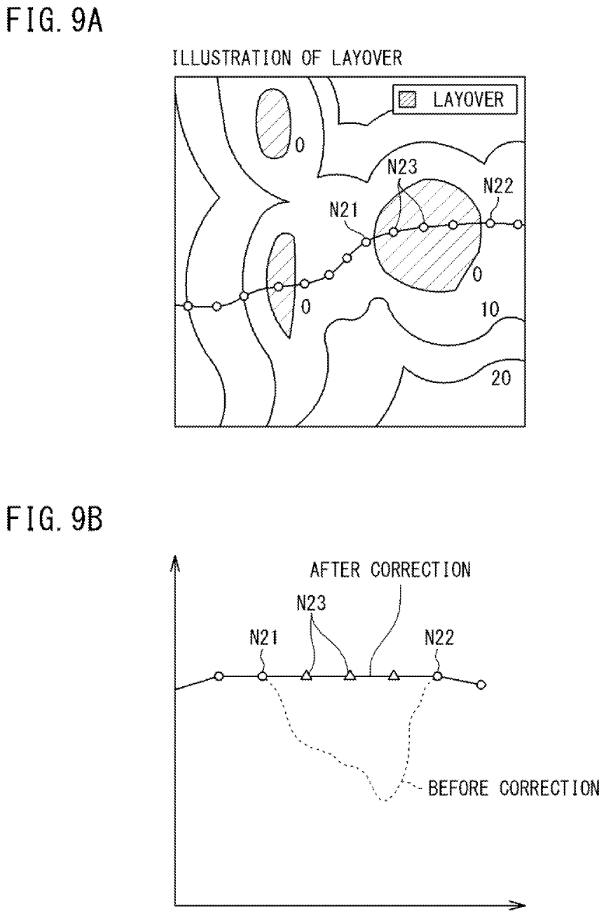

FIGS. 9A and 9B are illustrations of layover correction step S32. The smaller the local incident angle (LIA) is, the higher the possibility that layover occurs. Here, the local incident angle is an angle formed by a normal line of the object and a line drawn from the object to the satellite. Therefore, correction unit 33 determines that layover occurs in node N2 in which the local incident angle is equal to or less than the second predetermined value (for example, 0 degrees), and performs correction. FIG. 9A is a map showing the local incident angle of each point as a contour line. In FIG. 9A, the area where the local incident angle is 0 degrees or less is shaded.

FIG. 9B is a graph showing how the altitude value of node N2 is corrected in layover correction step S32. In FIG. 9B, node N2 at the point where the local incident angle is 0 degrees or less is indicated as an “abnormal node N23”. FIG. 9B includes an area in which three abnormal nodes N23 are continuous.

In addition, node N2 which is adjacent to abnormal node N23 via link L1 and in which the local incident angle exceeds the second predetermined value (that is, a node in which a layover is unlikely to occur) is referred to as a “normal node”. In FIG. 9B, it is indicated as normal nodes N21 and N22. Normal node N21 is a node adjacent to a first abnormal node N23. Normal node N22 is a node adjacent to a second abnormal node N23. In the embodiment of the present disclosure, node N2 in which the local incident angle is equal to the second predetermined value is abnormal node N23, but such node N2 may be the normal node. That is, correction unit 33 may determine node N2 whose local incident angle is smaller than the second predetermined value as an abnormal node, and determine node N2 which is adjacent to the abnormal node and whose local incident angle is equal to or more than the second predetermined value as a normal node.

In addition, node N2 corresponding to an abnormal node N26 in which a radar shadow to be described later is highly likely to occur may be excluded from normal nodes N21 and N22. That is, normal nodes N21 and N22 are nodes adjacent to abnormal node N23 and corresponding to points at which the local incident angle exceeds the second predetermined value and the local incident angle is smaller than a third predetermined value to be described later.

Correction unit 33 corrects the altitude value of abnormal node N23 based on the altitude values of normal nodes N21 and N22. For example, correction unit 33 changes the altitude value of abnormal node N23 to an average value of the altitude value of normal node N21 and the altitude value of normal node N22. As in altitude correction step S44, when the altitude value of abnormal node N23 is corrected, the horizontal distance between abnormal node N23 and normal nodes N21 and N22 may be taken into consideration. Thus, layover correction step S32 is completed.

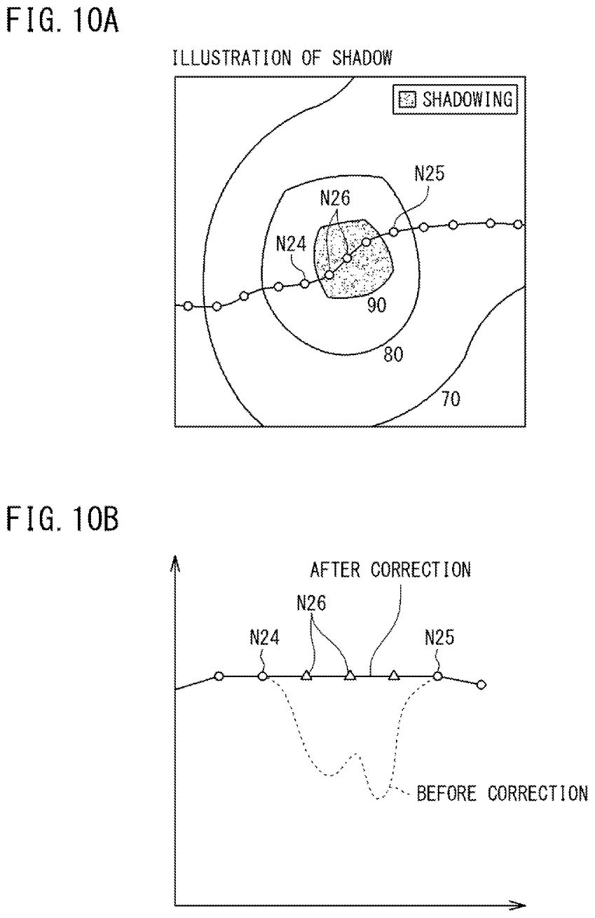

FIGS. 10A and 10B are illustrations of shadowing correction step S33. The larger the local incident angle is, the higher the possibility that radar shadow occurs. Therefore, correction unit 33 determines that node N2 included in the area in which the local incident angle is equal to or larger than the third predetermined value (for example, 90 degrees) has a radar shadow, and performs correction. Here, the third predetermined value is greater than the second predetermined value which is a boundary value at which layover occurs. FIG. 10A is a map showing the local incident angle of each point as a contour line. In FIG. 10A, the area where the local incident angle is 90 degrees or more is shaded.

FIG. 10B is a graph showing how the altitude value of node N2 is corrected in shadowing correction step S33. In FIG. 10B, node N2 at the point where the local incident angle is 90 degrees or more is indicated as “abnormal node N26”. FIG. 10B includes an area in which three abnormal nodes N26 are continuous.

In addition, node N2 which is adjacent to abnormal node N26 via link L1 and whose local incident angle is smaller than the third predetermined value (that is, a node having a low possibility of occurrence of shadowing) is referred to as a “normal node”. In FIG. 10B, it is indicated as normal nodes N24 and N25. Normal node N24 is a node adjacent to one side of abnormal node N26. Normal node N25 is a node adjacent to the other side of abnormal node N26. In the embodiment of the present disclosure, node N2 in which the local incident angle is equal to the third predetermined value is abnormal node N26, but such node N2 may be the normal node. That is, correction unit 33 may determine node N2 having a local incident angle exceeding a third predetermined value as an abnormal node, and determine node N2 adjacent to the abnormal node and having a local incident angle equal to or less than the third predetermined value as a normal node.

In addition, node N2 corresponding to abnormal node N23 having a high possibility of occurrence of layover may be excluded from normal nodes N24 and N25. That is, normal nodes N24 and N25 are nodes adjacent to abnormal node N26 and corresponding to points at which the local incident angle exceeds the second predetermined value and the local incident angle is smaller than the third predetermined value to be described later.

Correction unit 33 corrects the altitude value of abnormal node N26 based on the altitude values of normal nodes N24 and N25. For example, correction unit 33 changes the altitude value of abnormal node N26 to an average value of the altitude value of normal node N24 and the altitude value of normal node N25. As in altitude correction step S44 described above, when the altitude value of abnormal node N26 is corrected, the horizontal distances between abnormal node N26 and normal nodes N24 and N25 may be taken into consideration. Thus, shadowing correction step S33 is completed.

In layout over correction step S32 and shadowing correction step S33, the altitude value of the abnormal node is corrected based on the altitude values of the normal nodes adjacent to the abnormal node. Usually, the gradient of the road on which the vehicle travels does not change suddenly. Therefore, it is possible to acquire a more accurate altitude value by correcting the altitude value of a node (abnormal node) having a high possibility that an accurate altitude value is not obtained due to layover or radar shadow based on the altitude value of a node (normal node) adjacent to the node and having a high possibility that an accurate altitude value is obtained.

By correcting the altitude value of node N2 by elevated road correction step S31, layover correction step S32, and shadowing correction step S33, a node N3 including the corrected altitude value is generated. As a result, corrected data D4 (that is, corrected road altitude data) including a plurality of nodes N3 and a plurality of links L1 is generated. Finally, correction unit 33 stores corrected data D4 in second road altitude database 24. Thus, correction step S13 is completed.

Next, road gradient data generation unit 34 performs a road gradient data generation step S14 (“second generation step” in the present disclosure). First, road gradient data generation unit 34 reads corrected data D4 from second road altitude database 24. Next, a gradient g2 is calculated based on corrected data D4.

The calculation method of gradient g2 is similar to the calculation method of gradient g1 in gradient calculation step S41 described above. The difference is that gradient g1 is calculated based on node N2 before the altitude value is corrected, whereas gradient g2 is calculated based on node N3 after the altitude value is corrected. That is, road gradient data generation unit 34 calculates gradient g2 between two nodes N3 located at the start point and the end point of link L1. Then, road gradient data generation unit 34 generates a link L2 by adding calculated gradient g2 to the information of corresponding link L1. As a result, as shown in part (E) of FIG. 4, road gradient data D5 including a plurality of nodes N3 and a plurality of links L2 is generated. Finally, road gradient data generation unit 34 stores road gradient data D5 in road gradient database 25. Thus, gradient data generation step S14 is completed.

As described above, data generation apparatus 30 generates road altitude data D3 based on altitude data D1 generated from the SAR data and road map data D2, generates corrected data D4 by correcting the altitude value of road altitude data D3, and generates road gradient data D5 by calculating gradient g2 based on corrected data D4. Road gradient data D5 is used for a route search processing of route search apparatus 40 described next.

### <<Route Search Processing>>

Link L1 of road map data D2 includes the information on link cost LC as described above, and the information on link cost LC is taken over to link L2 of road gradient data D5 as it is. Link cost LC is a value representing a load applied to the vehicle when the vehicle travels through link L1, and is calculated from information such as a link travel time LT and a link distance LD. The link travel time LT is, for example, the time required by entering the start point of link L1, exiting the end point of the same link L1, and entering the start point of another link L1 to be connected next. Link distance LD is, for example, a distance between the start point and the end point of link L1.

Reference is made to FIG. 1. Route search apparatus 40 searches for a route that minimizes the traffic cost (cumulative total of link costs LC) using a search algorithm based on, for example, the Dijkstra method or the potential method. The Dijkstra method is a search algorithm in which when a tree is formed from a start link to intermediate links, if a branch is made from a certain intermediate link to another intermediate link, the route costs including the intermediate link after the branch (the cumulative total of link costs LC from the start link to the intermediate link after the branch) are compared and rearranged in ascending order of the route costs, and the search is continued from the intermediate link having the smallest route cost.

Route search apparatus 40 receives a search request from electric vehicle EV1. The search request includes information about the departure point and the destination point. Route search apparatus 40 searches for a route suitable for electric vehicle EV1 to travel, based on the search request and link cost LC included in road gradient data D5.

Next, route search apparatus 40 predicts the power consumption of electric vehicle EV1 at each point in the searched route based on link cost LC and gradient g2 included in road gradient data D5. In particular, since the power consumption of electric vehicle EV1 is greatly affected by the gradient of the road, it is possible to more accurately predict the power consumption by incorporating gradient g2 into the prediction of the power consumption.

Then, route search apparatus 40 predicts the remaining battery level of electric vehicle EV1 at each point in the searched route by subtracting the predicted power consumption from the remaining battery level of electric vehicle EV1 at the departure point. As a result, route search apparatus 40 can present at which timing electric vehicle EV1 should stop at the charging spot in the searched route. Then, if necessary, route search apparatus 40 changes the searched route to a route that allows the user to stop at the charging spot at a suitable timing. As a result, it is possible to alleviate the passenger's anxiety that the remaining battery level of electric vehicle EV1 will run out on the way to the destination point.

As described above, according to data generation apparatus 30, it is possible to provide route search apparatus 40 with data (road gradient data) capable of guiding a more suitable route during the route search.

### <<Modifications>>

Modifications of the embodiment will be described below. In the modifications, portions that are not changed from the embodiment are denoted by the same reference numerals, and description thereof is omitted.

### <<Modification 1 of Altitude Data Generation Unit>>

In the above embodiment, altitude data generation unit 31 generates altitude data D1 based on the SAR data. Here, since the SAR data is data based on radio waves emitted from a satellite and reflected on a ground surface, the SAR data is affected by weather and temperature of the ground surface. For example, some radio waves may be reflected by a thick cloud. Therefore, the SAR data may vary depending on the date on which the SAR data is acquired.

Therefore, altitude data generation unit 31 may generate a plurality of altitude data D1 using SAR data observed at different dates and times as original data, and set a statistical value (for example, a median value, an average value, or a mode value) of the plurality of altitude data D1 as a true value of altitude data D1. For example, altitude data generation unit 31 generates first altitude data based on first SAR data observed at the first date and time, and generates second altitude data based on second SAR data observed at the second date and time. Then, altitude data D1 is generated as an average value of the first altitude data and the second altitude data. With this configuration, the influence of, for example, weather can be leveled, and more accurate altitude data D1 can be acquired.

### <<Modification 2 of Altitude Data Generation Unit>>

Altitude data generation unit 31 of the above embodiment converts the absolute value of the phase after the offset into the altitude value (z) of the ground surface using the DEM data (phase-height conversion step S25). However, since data generation apparatus 30 only needs to be able to finally calculate gradient g2 of the road, the altitude value of altitude data D1 does not necessarily represent the altitude value of the ground surface (i.e., how many meters above sea level) as long as the relative altitude value between points is accurate. Therefore, phase-height conversion step S25 may be omitted, and the absolute value of the phase after the offset may be used as the altitude value of altitude data D1 as it is. In this case, the number of steps in altitude data generation unit 31 can be reduced, and the DEM data is also unnecessary.

For example, it is assumed that the absolute value of the phase after the offset of the point A is the 200 m, and the actual value is 100 m above sea level. In addition, it is assumed that the absolute value of the phase after the offset of the point B is 250 m, and the actual value is 150 m above sea level. In this case, if phase-height conversion step S25 is omitted, the altitude values of the points A and B are 200 m and 250 m, respectively, which are deviated from the actual altitude values by 100 m. However, since the difference in altitude value between the points A and B is the 50 m in both cases, gradient g2 becomes the same value whether phase-height conversion step S25 is executed or omitted.

### <<Modification of Road Altitude Data Generation Unit>>

In the above embodiment, road altitude data generation unit 32 generates road altitude data D3 based on altitude data D1 and road map data D2. Here, the altitude value of altitude data D1 may include noise due to, for example, weather as described above. For example, there may be a case where the altitude value is suddenly increased by 2 m at only one particular point. Normally, such a point is not considered on a road where a vehicle can pass, and is highly likely to be noise. Therefore, by correcting the altitude value of road altitude data D3 by a moving average, the altitude value of each point may be smoothed to remove noise.

For example, the average value (z31+z32+z33)/3 of an altitude value z31 of particular node N2 and altitude values z32 and z33 of two nodes N2 adjacent to the particular node N2 at a first position and a second position via links L1 is set as the altitude value after correction of the particular node N2. As a result, the influence of noise can be eliminated, and more accurate road altitude data D3 can be acquired.

### <<Modification 1 of Correction Unit>>

In the above embodiment, after extracting link L1 in which gradient g1 is equal to or greater than the first predetermined value in extraction step S42, correction unit 33 determines whether or not the road corresponding to link L1 is an elevated road by visual observation of the operator or based on the road type of link L1. However, in the case where the determination is made by visual observation of the operator, although more reliable determination is possible, there is a possibility that the work burden on the operator increases. There is also a region where the road type indicating whether or not the road is an elevated road is not assigned to link L1. Therefore, correction unit 33 according to the modification determines whether or not the road corresponding to link L1 is an elevated road based on analysis of a reflection intensity image.

Here, the reflection intensity image is an image representing the intensity of the reflected wave from the ground surface in the SAR data. The intensity of the reflected wave is represented by a pixel value. For example, in the reflection intensity image, an area having small reflection is displayed in black and an area having large reflection is displayed in white. The intensity of the reflected wave depends on the topography and the condition of the ground surface. For example, on a ground surface having a smooth surface such as a water surface or an elevated road, the radio wave emitted from the satellite is almost regularly reflected, and thus the radio wave hardly returns to the satellite, and the intensity of the reflected wave tends to be weak (black in the image). On the other hand, on a ground surface having a rough surface such as a forest, the radio wave emitted from the satellite is scattered, and thus a part of the radio wave returns to the satellite and the intensity of the reflected wave tends to be strong (white in the image).

Therefore, after extracting link L1 in which gradient g1 is equal to or greater than the first predetermined value in extraction step S42, correction unit 33 determines whether or not link L1 is an elevated road based on the reflection intensity of the point corresponding to link L1 in the reflection intensity image. Note that correction unit 33 may include other points located within a predetermined distance range (for example, within the range of 100 meters square) from the point corresponding to link L1 as the points on which the determination is based, or may determine based on only on the reflection intensity of the other points. If it is determined that link L1 is an elevated road, correction unit 33 proceeds to altitude correction step S44, and if it is determined that link L1 is not an elevated road, correction unit 33 terminates elevated road correction step S31.

In this way, by determining whether or not the road corresponding to link L1 is an elevated road based on the reflection intensity image, operator confirmation step S43 can be omitted, and the altitude value can be corrected more easily in a shorter time.

### <<Modification 2 of Correction Unit>>

In the above embodiment, in elevated road correction step S31, correction unit 33 corrects the altitude value of node N2 that has a high possibility of being actually an elevated road but has not acquired the altitude value as an elevated road. Here, since the SAR data is data based on reflection from the ground surface, the altitude value of the tunnel road cannot be acquired. Therefore, when the road type of link L1 is tunnel road, it is necessary to correct the altitude value.

Correction unit 33 of this modification further performs a tunnel road correction step S34 in addition to elevated road correction step S31. Tunnel road correction step S34 is one step executed in correction step S13. Tunnel road correction step S34 may be executed before elevated road correction step S31, or may be executed after elevated road correction step S31.

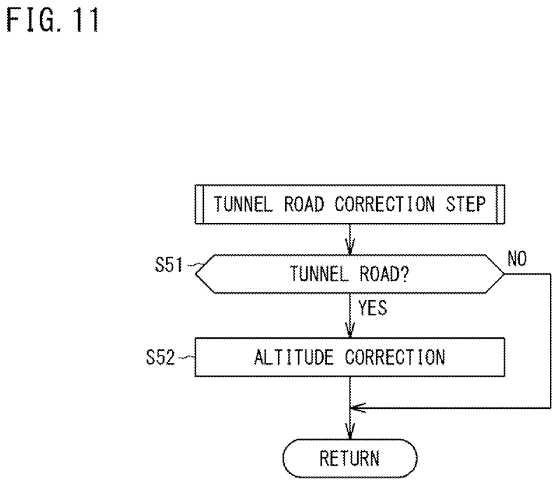

FIG. 11 is a flowchart showing a subroutine of tunnel road correction step S34. First, correction unit 33 reads road altitude data D3 from first road altitude database 23 and determines whether or not the road type of link L1 is a tunnel road (a tunnel road determination step S51). If the road type of link L1 is a tunnel road (YES route of S51 in FIG. 11), the process proceeds to an altitude correction step S52. If the road type of link L1 is other than tunnel road (NO route of S51 in FIG. 11), tunnel road correction step S34 is completed.

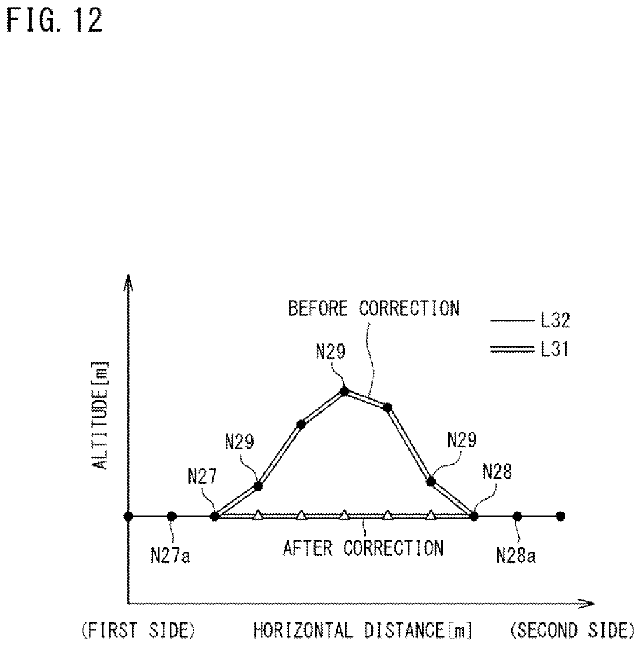

FIG. 12 is a graph showing altitude correction step S52. The vertical axis of FIG. 12 is altitude value and the horizontal axis is horizontal distance. The left side of the horizontal axis is referred to as a first side, and the right side is referred to as a second side. In FIG. 12, link L1 whose road type is a tunnel road is indicated as a “tunnel link L31”, and link L1 whose road type is other than a tunnel road is indicated as a “non-tunnel link L32”.

Nodes N2 connected to tunnel link L31 on both the first side and the second side are referred to as “abnormal nodes N29”. Abnormal nodes N29 are nodes N2 set in the tunnel road, since link L1 on the inflow side and link L1 on the outflow side are both tunnel link L31. For this reason, the altitude values of abnormal nodes N29 are not the altitude values of the original tunnel road but the altitude values of the surface of the mountain through which the tunnel road passes, and the altitude values need to be corrected.

Here, node N2 in which one of the first side and the second side is connected to tunnel link L31 and the other of the first side and the second side is connected to a non-tunnel link L32 is referred to as a “normal node”. In FIG. 12, a normal node N27 is node N2 whose second side is connected to tunnel link L31 and whose first side is connected to non-tunnel link L32, and a normal node N28 is node N2 whose first side is connected to tunnel link L31 and whose second side is connected to non-tunnel link L32. As described above, node N2 located at the boundary between tunnel link L31 and non-tunnel link L32 is considered to be node N2 set at the entrance or the exit of the tunnel road (or in the vicinity thereof). In the SAR data, since it is considered that a correct altitude value has been acquired until immediately before entering the tunnel road, the altitude value of abnormal node N29 is corrected based on the altitude values of normal nodes N27 and N28.

Specifically, correction unit 33 changes the altitude value of abnormal node N29 to the average value of normal node N27 and normal node N28. As in altitude correction step S44, when the altitude value of abnormal node N29 is corrected, the horizontal distances between abnormal node N29 and normal nodes N27 and N28 may be taken into consideration. By correcting the altitude value of abnormal node N29, an accurate altitude value may be acquired. Thus, altitude correction step S52 is completed.

Depending on the resolution of the SAR data, a correct altitude value may not be acquired immediately before entering the tunnel road. Therefore, node N2 that satisfies the condition of normal nodes N27 and N28 may be set as abnormal node N29 that needs correction, and node N2 that is connected to non-tunnel link L32 on both the first side and the second side and is adjacent to abnormal node N29 via non-tunnel link L32 may be set as the “normal node”. In this case, nodes N27a and N28a shown in FIG. 12 become normal nodes.

### <<Others>>

Road gradient data generation unit 34 according to the above-described embodiment calculates gradient g2 between two nodes N3 located at the start point and the end point of one link L1. However, gradient g2 may be a gradient between any two nodes N3, and the number of links L1 between nodes N3 may be two or more. For example, the gradient between node N3 located on the most upstream side (that is, the start point of the series and continuous link group) among the plurality of links L1 (link group) that are continuous in series and node N3 located on the most downstream side (that is, the end point of the series and continuous link group) among the plurality of links L1 may be calculated as gradient g2.

In road gradient data D5 according to the above embodiment, gradient g2 is stored as information of link L2. However, in road gradient data D5, the method of storing gradient g2 is not limited. For example, gradient g2 may be assigned as coordinate information (x, y, z, g2) of node N3. Gradient g2 may be stored in road gradient data D5 as independent information without being assigned to any of link L2 and node N3.

The gradient information according to the above embodiment is gradient g2 between two nodes N3. However, the gradient information may be any information indicating the inclination of the road, and may be a numerical value other than the gradient, or may be information indicating the degree of the gradient. For example, the gradient may be divided into predetermined numerical ranges, and information such as “gradient is large”, “gradient is small”, or “gradient is not present” may be used as the gradient information. When calculating the remaining battery level of electric vehicle EV1, the required calculation accuracy can be ensured if an approximate gradient level is obtained, and when a specific gradient value is not required, the gradient information is preferably used as information representing the gradient level in order to reduce the amount of data.

Altitude data D1 according to the above embodiment is generated based on the SAR data. However, altitude data D1 may be generated based on data other than the SAR data. For example, altitude data D1 may be based on data acquired by radiating a radio wave to a ground surface using a flying object other than a satellite, such as an unmanned airplane, and receiving the wave reflected on the ground surface by the flying object.

### <<Supplemental Note>>

It should be noted that at least a part of the above-described embodiments and various modifications may be combined with each other in any combination. It should be understood that the embodiments disclosed herein are illustrative in all respects and are not restrictive. The scope of the present disclosure is defined by the appended claims, and all changes that come within the meaning and range of equivalency of the claims are intended to be embraced therein.

### REFERENCE SIGNS LIST

100 route search system
10 communication unit
20 database
21 altitude database
22 road map database
23 first road altitude database
24 second road altitude database
25 road gradient database
30 data generation apparatus
31 altitude data generation unit
32 road altitude data generation unit
33 correction unit
34 road gradient data generation unit
40 route search apparatus
50 satellite database
61 display unit
62 input unit
D1 altitude data
D2 road map data
D3 road altitude data
D4 corrected data (corrected road altitude data)
D5 road gradient data
NT1 communication network
EV1 electric vehicle
N1 node
N2 node (to which altitude value is given)
N3 node (for which altitude value is corrected)
N11, N12 normal node (first normal node)
N13 abnormal node (first abnormal node)
N21, N22 normal node (second normal node)
N23 abnormal node (second abnormal node)
N24, N25 normal node (third normal node)
N26 abnormal node (third abnormal node)
N27, N28 normal node (fourth normal node)
N27a, N28a node (fourth normal node)
N29 abnormal node (fourth abnormal node)
L1 link
L2 link (to which gradient is given)
L31 tunnel link
L32 non-tunnel link
LC link cost
LT link travel time
LD link distance
g1 gradient (between nodes N2)
g2 gradient (between nodes N3)
AR1, AR2, AR3 area

1. A data generation apparatus comprising:
a first generation unit configured to, based on altitude data including altitude values of a plurality of points and road map data indicating roads with a plurality of nodes and a plurality of links, generate road altitude data in which each of the plurality of nodes is given an altitude value of a corresponding one of the plurality of points; and
a second generation unit configured to, based on the road altitude data, calculate gradient information indicating a gradient between any two nodes among the plurality of nodes and generate road gradient data in which the plurality of nodes or the plurality of links are given the gradient information.

2. The data generation apparatus according to claim 1, further comprising:
a third generation unit configured to generate the altitude data, based on synthetic aperture radar (SAR) data obtained by a synthetic aperture radar.

3. The data generation apparatus according to claim 2, wherein
the third generation unit is configured to generate a plurality of pieces of the altitude data, based on the SAR data observed on different dates and times, and regard a statistical value of the generated plurality of pieces of the altitude data as a true value of the altitude data.

4. The data generation apparatus according to claim 2, further comprising:
a correction unit configured to correct an altitude value given to a node among the plurality of nodes, wherein
the correction unit is configured to correct an altitude value of an abnormal node, based on an altitude value of a normal node, the abnormal node being a node, among the plurality of nodes, that satisfies a correction condition, the normal node being a node, among the plurality of nodes, that does not satisfy the correction condition and is adjacent to the abnormal node, and
the second generation unit is configured to generate the road gradient data, based on the road altitude data that has been corrected.

5. The data generation apparatus according to claim 4, wherein
the abnormal node includes a first abnormal node connected to a target link, the target link being a link corresponding to an elevated road and having a gradient exceeding a first predetermined value, the gradient being between a start point and an end point of the link,
the normal node includes a first normal node adjacent to the first abnormal node and connected to a non-target link, the non-target link not being the target link, and
the correction unit is configured to correct an altitude value of the first abnormal node, based on an altitude value of the first normal node.

6. The data generation apparatus according to claim 5, wherein
the correction unit is configured to determine whether the link corresponds to an elevated road, based on a reflection intensity of at least one of a point corresponding to the link or a point located within a range of a predetermined distance from the point, in a reflection intensity image representing an intensity of a reflected wave returning from a ground surface to a satellite.

7. The data generation apparatus according to claim 4, wherein
the abnormal node includes a second abnormal node corresponding to a point at which a local incident angle in the SAR data is smaller than a second predetermined value,
the normal node includes a second normal node adjacent to the second abnormal node and corresponding to a point at which the local incident angle is greater than the second predetermined value, and
the correction unit is configured to correct an altitude value of the second abnormal node, based on an altitude value of the second normal node.

8. The data generation apparatus according to claim 4, wherein
the abnormal node includes a third abnormal node corresponding to a point at which a local incident angle in the SAR data is greater than a third predetermined value,
the normal node includes a third normal node adjacent to the third abnormal node and corresponding to a point at which the local incident angle is smaller than the third predetermined value, and
the correction unit is configured to correct an altitude value of the third abnormal node, based on an altitude value of the third normal node.

9. The data generation apparatus according to claim 4, wherein
the abnormal node includes
a second abnormal node corresponding to a point at which a local incident angle in the SAR data is smaller than a second predetermined value, the local incident angle smaller than the second predetermined value causing layover in the SAR data, and
a third abnormal node corresponding to a point at which the local incident angle is greater than a third predetermined value, the local incident angle greater than the third predetermined value causing radar shadow in the SAR data,
the third predetermined value is greater than the second predetermined value,
the normal node includes
a second normal node adjacent to the second abnormal node and corresponding to a point at which the local incident angle is greater than the second predetermined value and smaller than the third predetermined value, and
a third normal node adjacent to the third abnormal node and corresponding to a point at which the local incident angle is greater than the second predetermined value and smaller than the third predetermined value, and
the correction unit is configured to
correct an altitude value of the second abnormal node, based on an altitude value of the second normal node, and
correct an altitude value of the third abnormal node, based on an altitude value of the third normal node.

10. The data generation apparatus according to claim 4, wherein
the abnormal node includes a fourth abnormal node connected to a tunnel link, the tunnel link being a link corresponding to a tunnel road,
the normal node includes a fourth normal node connected to a non-tunnel link, the non-tunnel link being a link adjacent to the fourth abnormal node and corresponding to a road other than the tunnel road, and
the correction unit is configured to correct an altitude value of the fourth abnormal node, based on an altitude value of the fourth normal node.

11. A data generation method comprising:
a first generation step of, based on altitude data including altitude values of a plurality of points and road map data indicating roads with a plurality of nodes and a plurality of links, generating road altitude data in which each of the plurality of nodes is given an altitude value of a corresponding one of the plurality of points; and
a second generation step of, based on the road altitude data, calculating gradient information indicating a gradient between any two nodes among the plurality of nodes and generating road gradient data in which the plurality of nodes or the plurality of links are given the gradient information.

12. A non-transitory computer readable storage medium storing a computer program for causing a computer to operate as a data generation apparatus, the computer program comprising:
a first generation step of, based on altitude data including altitude values of a plurality of points and road map data indicating roads with a plurality of nodes and a plurality of links, generating road altitude data in which each of the plurality of nodes is given an altitude value of a corresponding one of the plurality of points; and
a second generation step of, based on the road altitude data, calculating gradient information indicating a gradient between any two nodes among the plurality of nodes and generating road gradient data in which the plurality of nodes or the plurality of links are given the gradient information.
